(19) United States
(12) Patent Application Publication
(10) Pub. No.: US 2018/0068245 A1
(43) Pub. Date: Mar. 8, 2018

(54) USING BEST PRACTICES CUSTOMER ADOPTION BUSINESS INTELLIGENCE DATA AS INPUT TO ENTERPRISE RESOURCE PLANNING (ERP)

(71) Applicant: International Business Machines Corporation, Armonk, NY (US)

(72) Inventors: Thomas W. Conti, Poughkeepsie, NY (US); Kyle R. Moser, Stone Ridge, NY (US)

(21) Appl. No.: 15/259,107

(22) Filed: Sep. 8, 2016

(51) Int. Cl. G06Q 10/06; G06F 9/50; G06F 11/36; G06Q 30/02

(52) U.S. Cl. CPC G06Q 10/06313; G06F 9/50; G06Q 30/0201; G06F 11/3616; G06F 11/3692

(57) ABSTRACT

Aspects of the present invention include a method, system and computer program product. The method includes a processor setting one or more best practices attainment goals for each one of one or more customers of a business entity; collecting actual best practices attainment values achieved by each one of the one or more customers of a business entity; comparing each one of the actual best practices attainment values to the corresponding one of the one or more best practices attainment goals for each one of one or more customers of a business entity; determining that each one of the actual best practices attainment values at least meets or does not at least meet the corresponding one of the one or more best practices attainment goals for each one of one or more customers of a business entity, and maintaining corresponding best practices resource allocations or reallocating corresponding best practices resources.

### BACKGROUND

The present invention relates to the testing of software, hardware, firmware, and/or other disciplines, and more specifically, to a method, system and computer program product that implement aspects of workload and operational profiling, coupled with business analytics, thereby resulting in improvements in the testing of customer software.

In the field of software testing, as in many other technical fields, improvements are constantly being sought, primarily for cost and accuracy reasons. A fundamental goal of software testing in theory is to identify all of the problems in a customer's software program before the program is released for use by the customer. However, in reality this is far from the case as typically a software program is released to the customer having some number of problems that were unidentified during the software development and testing process.

A relatively more proactive approach to improving software testing is sought that employs traditional methods of understanding characteristics of clients' environments, augmented with a process of data mining empirical systems data. Such client environment and workload profiling analysis may result in software test improvements based on characteristics comparisons between the client and the test environments.

### SUMMARY

According to one or more embodiments of the present invention, a computer-implemented method includes setting, by a processor, one or more best practices attainment goals for each one of one or more customers of a business entity; collecting, by the processor, actual best practices attainment values achieved by each one of the one or more customers of a business entity; and comparing, by the processor, each one of the actual best practices attainment values to the corresponding one of the one or more best practices attainment goals for each one of one or more customers of a business entity. The method also includes determining, by the processor, that each one of the actual best practices attainment values at least meets the corresponding one of the one or more best practices attainment goals for each one of one or more customers of a business entity, and maintaining, by the processor, corresponding best practices resource allocations; and determining, by the processor, that each one of the actual best practices attainment values does not at least meet the corresponding one of the one or more best practices attainment goals for each one of one or more customers of a business entity, and reallocating, by the processor, corresponding best practices resources.

According to another embodiment of the present invention, a system includes a processor in communication with one or more types of memory, the processor configured to set one or more best practices attainment goals for each one of one or more customers of a business entity; to collect actual best practices attainment values achieved by each one of the one or more customers of a business entity; and to compare each one of the actual best practices attainment values to the corresponding one of the one or more best practices attainment goals for each one of one or more customers of a business entity. The processor is also configured to determine that each one of the actual best practices attainment values at least meets the corresponding one of the one or more best practices attainment goals for each one of one or more customers of a business entity, and to maintain corresponding best practices resource allocations; and to determine that each one of the actual best practices attainment values does not at least meet the corresponding one of the one or more best practices attainment goals for each one of one or more customers of a business entity, and to reallocate corresponding best practices resources.

According to yet another embodiment of the present invention, a computer program product includes a non-transitory storage medium readable by a processing circuit and storing instructions for execution by the processing circuit for performing a method that includes setting, by a processor, one or more best practices attainment goals for each one of one or more customers of a business entity; collecting, by the processor, actual best practices attainment values achieved by each one of the one or more customers of a business entity; and comparing, by the processor, each one of the actual best practices attainment values to the corresponding one of the one or more best practices attainment goals for each one of one or more customers of a business entity. The method also includes determining, by the processor, that each one of the actual best practices attainment values at least meets the corresponding one of the one or more best practices attainment goals for each one of one or more customers of a business entity, and maintaining, by the processor, corresponding best practices resource allocations; and determining, by the processor, that each one of the actual best practices attainment values does not at least meet the corresponding one of the one or more best practices attainment goals for each one of one or more customers of a business entity, and reallocating, by the processor, corresponding best practices resources.

Additional features and advantages are realized through the techniques of the present invention. Other embodiments and aspects of the invention are described in detail herein and are considered a part of the claimed invention. For a better understanding of the invention with the advantages and the features, refer to the description and to the drawings.

### BRIEF DESCRIPTION OF THE DRAWINGS

The subject matter which is regarded as the invention is particularly pointed out and distinctly claimed in the claims at the conclusion of the specification. The forgoing and other features, and advantages of the invention are apparent from the following detailed description taken in conjunction with the accompanying drawings in which:

FIG. 1 depicts a cloud computing environment according to one or more embodiments of the present invention;

FIG. 2 depicts abstraction model layers according to one or more embodiments of the present invention;

FIG. 3 is a block diagram illustrating one example of a processing system for practice of the teachings herein; and

FIG. 4 is a flow diagram of a method for using a customer's best practices attainment values as input to an enterprise resource planning system for use thereby in accordance with one or more embodiments of the present invention.

### DETAILED DESCRIPTION

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

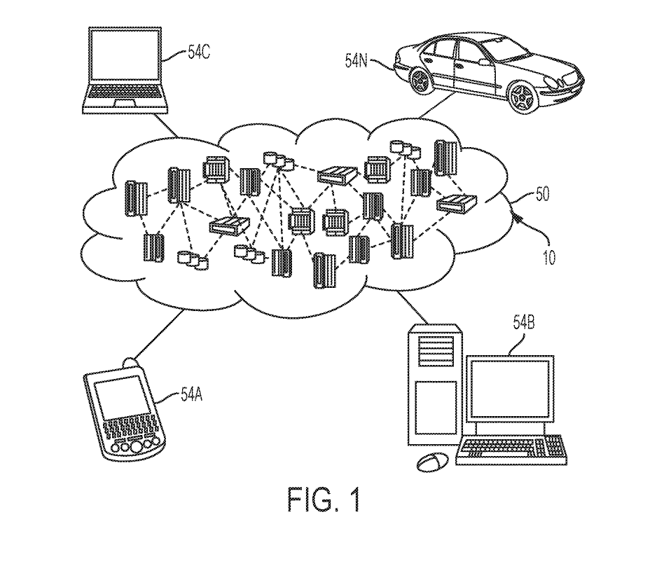

Referring now to FIG. 1, illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 1 are intended to be illustrative only and that computing nodes 10 and cloud computing environment 50 can communicate with any type of computerized device over any type of network and/or network addressable connection (e.g., using a web browser).

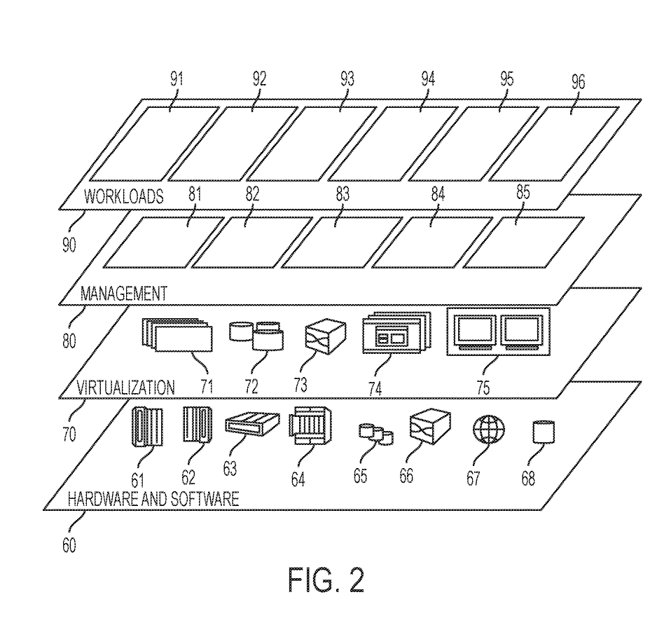

Referring now to FIG. 2, a set of functional abstraction layers provided by cloud computing environment 50 (FIG. 1) is shown. It should be understood in advance that the components, layers, and functions shown in FIG. 2 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and a method 96 for using a customer's best practices attainment values as input to an enterprise resource planning system for use thereby in accordance with one or more embodiments of the present invention.

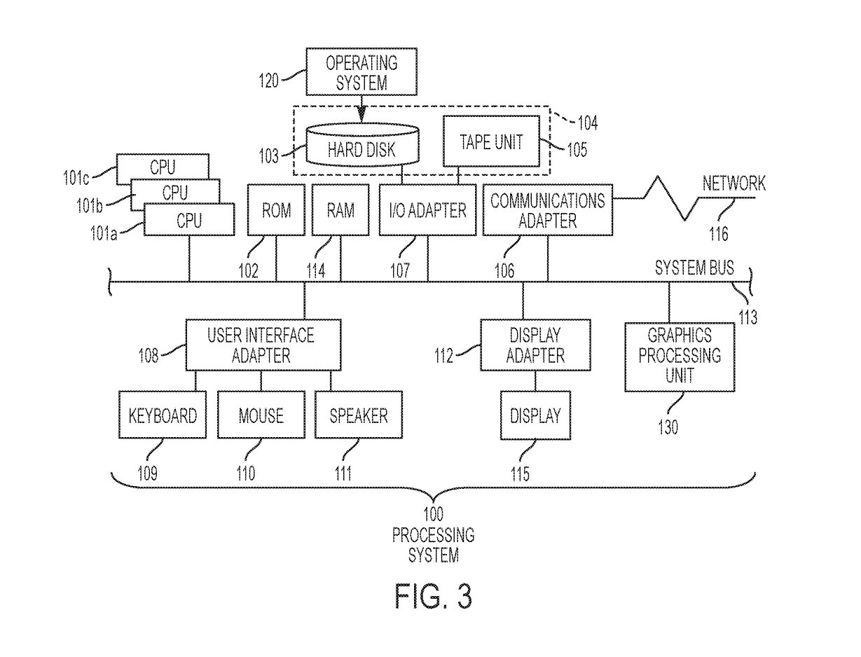

Referring to FIG. 3, there is shown a processing system 100 for implementing the teachings herein according to one or more embodiments. The system 100 has one or more central processing units (processors) 101a, 101b, 101c, etc. (collectively or generically referred to as processor(s) 101). In one embodiment, each processor 101 may include a reduced instruction set computer (RISC) microprocessor. Processors 101 are coupled to system memory 114 and various other components via a system bus 113. Read only memory (ROM) 102 is coupled to the system bus 113 and may include a basic input/output system (BIOS), which controls certain basic functions of system 100.

FIG. 3 further depicts an input/output (I/O) adapter 107 and a network adapter 106 coupled to the system bus 113. I/O adapter 107 may be a small computer system interface (SCSI) adapter that communicates with a hard disk 103 and/or tape storage drive 105 or any other similar component. I/O adapter 107, hard disk 103, and tape storage device 105 are collectively referred to herein as mass storage 104. Operating system 120 for execution on the processing system 100 may be stored in mass storage 104. A network adapter 106 interconnects bus 113 with an outside network 116 enabling data processing system 100 to communicate with other such systems. A screen (e.g., a display monitor) 115 is connected to system bus 113 by display adaptor 112, which may include a graphics adapter to improve the performance of graphics intensive applications and a video controller. In one embodiment, adapters 107, 106, and 112 may be connected to one or more I/O busses that are connected to system bus 113 via an intermediate bus bridge (not shown). Suitable I/O buses for connecting peripheral devices such as hard disk controllers, network adapters, and graphics adapters typically include common protocols, such as the Peripheral Component Interconnect (PCI). Additional input/output devices are shown as connected to system bus 113 via user interface adapter 108 and display adapter 112. A keyboard 109, mouse 110, and speaker 111 all interconnected to bus 113 via user interface adapter 108, which may include, for example, a Super I/O chip integrating multiple device adapters into a single integrated circuit.

In exemplary embodiments, the processing system 100 includes a graphics processing unit 130. Graphics processing unit 130 is a specialized electronic circuit designed to manipulate and alter memory to accelerate the creation of images in a frame buffer intended for output to a display. In general, graphics processing unit 130 is very efficient at manipulating computer graphics and image processing, and has a highly parallel structure that makes it more effective than general-purpose CPUs for algorithms where processing of large blocks of data is done in parallel.

Thus, as configured in FIG. 3, the system 100 includes processing capability in the form of processors 101, storage capability including system memory 114 and mass storage 104, input means such as keyboard 109 and mouse 110, and output capability including speaker 111 and display 115. In one embodiment, a portion of system memory 114 and mass storage 104 collectively store an operating system to coordinate the functions of the various components shown in FIG. 3.

In accordance with one or more embodiments of the present invention, methods, systems, and computer program products are disclosed for using a customer's best practices attainment values as input to an enterprise resource planning system for use thereby. In other words, one or more embodiments of the present invention utilize a metric or measure (e.g., a score, a ranking, etc.) of how well a customer actually uses (i.e., attains) a business's best practices as compared to a desired level of usage of that business's best practices. In an embodiment, the best practices may comprise the IBM System z best practices.

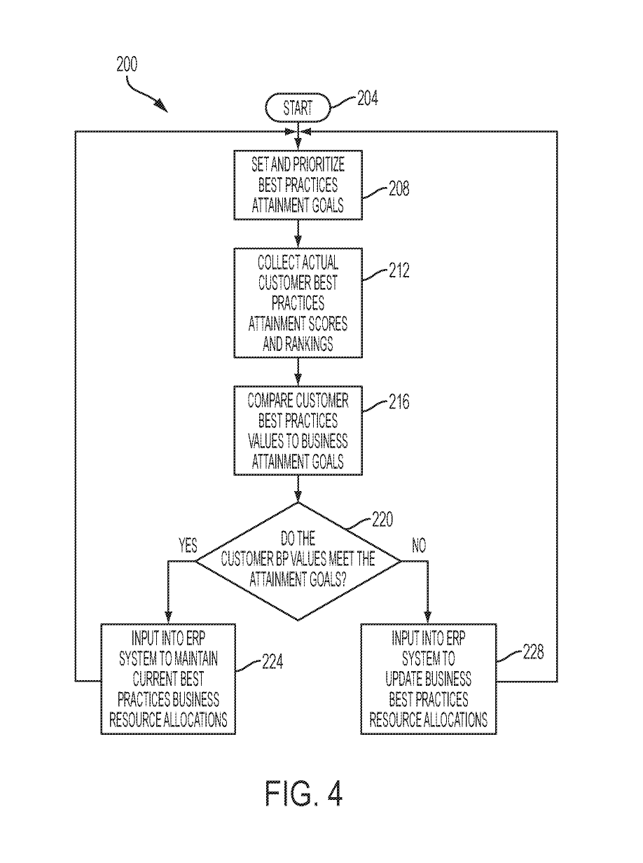

With reference now to FIG. 4, a flow diagram illustrates a method 200 according to one or more embodiments of the present invention for using a customer's best practices attainment values as input to an enterprise resource planning system for use thereby.

In one or more embodiments of the present invention, the method 200 may be embodied in software that is executed by computer elements located within a network that may reside in the cloud, such as the cloud computing environment 50 described hereinabove and illustrated in FIGS. 1 and 2. In other embodiments, the computer elements may reside on a computer system or processing system, such as the processing system 100 described hereinabove and illustrated in FIG. 3, or in some other type of computing or processing environment.

After a start operation in block 204, an operation in block 208 sets the best practices attainment goals based on the business requirements of the customer's business or enterprise. This may be performed for each one of one or more customers of a business entity such as IBM. This operation may also prioritize such best practices attainment goals.

An operation in block 212 collects the actual best practices attainment values (e.g., scores or rankings) achieved by each one of the one or more customers of the business entity. This may be carried out in a number of ways. For example, in an embodiment, an accounting may be performed of all best practices implementation data in categories, including, for example, from each operational, environmental, workload, application, and/or functional areas to be analyzed. Included may be various customer categories or groupings by geography, country, continent, industry, etc., and through multiple metrics or factors with multiple categories and scores and to determine an overall value for a best practices implementation score and ranking. A best practices value weighting may be established during best practices accounting. The best practices data points may be related by customer categories or groupings including by geography, country, continent, industry, etc., from each operational, environmental, workload, application, and/or functional areas to be analyzed.

Through consultation with subject matter experts (SME) from each operational, environmental, workload, application, and/or functional areas to be analyzed for best practices implementation, various formulas are determined to properly score and rank these best practices implementations. When customer best practices metrics are collected, simple or complex analysis may be accomplished by scoring and ranking the adoption and adherence to particular best practices using these formulas.

The relative customer best practices data is acquired using the current and continually expanding customer profiling and analytics discipline techniques for data collection and curation, including environment, workload and operational questionnaires, interviews, workshops, deep dives, problem history analysis, social and traditional media analysis, empirical data analysis, and more. The customer best practices implementation scores are then determined for each operational, environmental, workload, application, and/or functional areas to be analyzed, and the customer best practices implementation rankings are determined for each operational, environmental, workload, application, and/or functional areas to be analyzed in relation to various previously collected customer best practices implementation data and through a variety of customer groupings. These customer groupings may include by geography, country, culture, industry, etc. as well as the overall global customer set.

An operation in block 216 compares, for each best practices category of interest to the business or enterprise, the customer best practices attainment score or ranking values determined in the operation in block 212 to the best practices attainment goals of the business or enterprise set in the operation in block 208.

Next, a decision operation in block 220 determines whether or not the customer best practices attainment scores and rankings values at least meet the best practices attainment goals of the business or enterprise set in the operation in block 208. If so, the current best practices resource allocations are maintained so as to satisfy the business or enterprise attainment goals. An operation in block 224 inputs the customer best practices attainment scores and rankings, as well as the enterprise best practices attainment goals and priorities, into an appropriate enterprise resource planning (ERP) system to maintain best practices resource allocations with their current values. The method 200 then branches back to the operation in block 208. That is, the method 200 is done maintaining the best practices attainment goals and resource allocations and will iterate again when new data is available.

In accordance with embodiments of the present invention, the term “enterprise resource planning” (“ERP”) may be taken in a general context as opposed to a software specific definition and implementation of ERP. Such a general concept of ERP employs software solutions. Regardless, a business or enterprise in general strives to incorporate best practices into its ERP system, so that the ERP system reflects the business or enterprise's most effective way to perform each business process within the entire ERP system.

In contrast, if the customer best practices attainment scores and rankings values do not at least meet the best practices attainment goals of the business or enterprise set in the operation in block 208, then the method 200 chooses to analyze the customer best practices attainment scores and rankings together with the best practices attainment goals. This is done to determine the appropriate resources and optimal methodologies to achieve these best practices attainment goals and corresponding priorities. In an operation in block 228, the customer best practices attainment scores and rankings, as well as the enterprise best practices attainment goals and priorities, are input into an appropriate ERP system to determine the optimal business methods and funding to allocate the appropriate resources to achieve the target best practices attainment goals and corresponding priorities. The method 200 then branches back to the operation in block 208.

Embodiments of the present invention utilize customer profiling and analytics generated best practices data, at a wide range of customer and business entity best practices granularities or levels, to provide business intelligence on the customer, business entity, and/or business partner resources that may be needed to increase specific best practices rates of adoption, to increase an individual customer's rate of adoption, to increase customer groupings' rate of adoption, and/or to increase the overall customer community's rate of adoption.

The ERP business intelligence generated by embodiments of the present invention provides the customer, the business entity (e.g., IBM), and/or the business entity's business partners with valuable insight into where additional skills, education, technology adoption, cultural change within an organization or company, financial investment, hardware/software/services, and/or additional resources may be required to achieve greater adoption of the business entity's best practices. This ERP information may include from incremental to complete adoption at the individual, grouped, overall customer levels and best practices discipline. Embodiments may utilize a wide and diverse range of best practices metrics as input to an ERP system, which generates actionable business and financial information for customers, the business entity itself, and/or business partners of the business entity.

Embodiments of the present invention utilize the best practices business intelligence data to understand, rank, score, and visualize customer implementation of a business entity's best practices to identify what customer, business entity, and business partner resources may be required to increase best practices adoption. Also, this business intelligence data may be as input for enterprise resource planning for the customer, the business entity, and/or the business entity's business partners.

The business intelligence data can span a relatively wide range of customers and best practices to provide resource planning information from the smallest delineation to across an entire enterprise. With these granular and graduated levels of best practices enterprise resource planning requirements, the customer, the business entity, and the business partners can work together to determine what level of investment is feasible now, in the short term, and for longer term planning. This business intelligence data also may include incremental or complete solutions for best practices adoption.

Given a variety of significant and complex business challenges, it is more important than ever that the customers of a business entity, the business entity itself, and the business partners of the business entity work in partnership to optimize customer investments in products/services of the business entity, including through the implementation of the business entity's best practices. These significant and complex business challenges may include: ever increasing local, regional, country, and global business competition; evolving and ever more sophisticated security attacks and breaches; rising cost of goods, services, materials; skills shortages; a potential slowdown of Moore's Law with regards to processor chip technology; and many more.

Among the challenges that arise with such investment optimization is the amount and type of different resources (customer, business entity, business partner, etc.) that are required to achieve different levels of best practices adoption, for each discipline within and even beyond, for example, the IBM System z platform. Business intelligence input to ERP systems provides the necessary views on how to best implement varying degrees of these best practices.

Through business intelligence generated by customer profiling and analytics, the who, what, when, where, why and how of optimizing the range of best practices adoption can be answered as input to an ERP system. For example, for each IBM System z discipline and/or product, business intelligence can provide valuable ERP requirements input, at the Customer, IBM, business partner, and other levels, including: financial investment; human resources; physical assets including plants, labs, offices, etc.; manufacturing capabilities; product development; product support; project management; and marketing and sales.

Further, given that this best practices business intelligence information can be relatively granular, the ERP determined the cost of implementing specific best practices recommendations can be determined at these levels: individual discipline; individual customer; grouped customer; and global customer set.

With IBM System z disciplines' best practices business intelligence and ERP, estimates can be calculated for the costs and options and trade-offs of implementing specific incremental or complete adoptions of Best Practices. An example of best practices business intelligence and ERP includes a business entity's software product complexity requires significant resources and time to implement recommended best practices. Best practices analysis of a specific software product may indicate that a significant degree of the software best practice recommendations may not be implemented across numerous customers given the complexity required to implement. The business intelligence may also rank the individual software product's best practices recommendations in terms of customer and business entity importance.

With this business intelligence and ERP, the business entity can work to enhance the product to reduce the complexity and corresponding effort to implement the best practices. The business entity can determine the amount of technical resources and financial investment for the overall product, and for the individual product components, and determine what options, a subset of components, and trade-offs may be necessary to implement the greatest return on investment (ROI).

Another example is that a customer requires the business entity to implement security-related best practices. Given the business criticality of secure IT infrastructures, and the ever-evolving sophistication of security attacks and breaches, many customers are faced with the business requirement to implement greater security controls with limited skills sets. Security solutions (including hardware, software, and services) can provide the resources necessary to secure the customer enterprise.

Also, given that each customer's IT infrastructure is unique, including the degree to which security is currently implemented and the additional security measures that need to be enacted, there are a wide range of solutions. As security issues may be classified as low, medium, and high risk, a customer may wish to initially invest in addressing all of their high risk and some of their medium risk security vulnerabilities or issues. With security-related best practices business intelligence and ERP generated for the specific customer, the business entity can provide solutions estimates including hardware, software, services, etc. to meet the current and projected needs of the specific customer. The customer then can plan for the appropriate finances to achieve this goal.

Still another example is customer pricing incentives for a business entity's products needed to implement equivalent test environment to production environment. Many customers struggle with the challenge of configuring equivalent test and production environments. Customer test environments may only be able to serve the purpose of function test, as opposed to the more comprehensive systems level test approaching the levels of production. Test environment server, storage, network, software, and services resources may be moderately to even significantly less allocated than for the corresponding production environment. Given the uniqueness and complexity of every customer environment, including customer developed and OEM applications that are just not available to the business entity, a customer test environment that can closely match the corresponding production environment is a highly recommended best practice.

Some customers may need financial incentives to achieve the desired level of hardware, software, services, and skills equivalence between their test and production environments. Using IBM System z systems best practices business intelligence with ERP, IBM and its business partners can determine individual customer and group trends for these requirements, and work to provide customers with attractive financial incentives and leasing for them to achieve this recommended test to production environment equivalency.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

As used herein, the articles “a” and “an” preceding an element or component are intended to be nonrestrictive regarding the number of instances (i.e., occurrences) of the element or component. Therefore, “a” or “an” should be read to include one or at least one, and the singular word form of the element or component also includes the plural unless the number is obviously meant to be singular.

As used herein, the terms “invention” or “present invention” are non-limiting terms and not intended to refer to any single aspect of the particular invention but encompass all possible aspects as described in the specification and the claims.

As used herein, the term “about” modifying the quantity of an ingredient, component, or reactant of the invention employed refers to variation in the numerical quantity that can occur, for example, through typical measuring and liquid handling procedures used for making concentrates or solutions. Furthermore, variation can occur from inadvertent error in measuring procedures, differences in the manufacture, source, or purity of the ingredients employed to make the compositions or carry out the methods, and the like. In one aspect, the term “about” means within 10% of the reported numerical value. In another aspect, the term “about” means within 5% of the reported numerical value. Yet, in another aspect, the term “about” means within 10, 9, 8, 7, 6, 5, 4, 3, 2, or 1% of the reported numerical value.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method comprising:
setting, by a processor, one or more best practices attainment goals for each one of one or more customers of a business entity;
collecting, by the processor, actual best practices attainment values achieved by each one of the one or more customers of a business entity;
comparing, by the processor, each one of the actual best practices attainment values to the corresponding one of the one or more best practices attainment goals for each one of one or more customers of a business entity;
determining, by the processor, that each one of the actual best practices attainment values at least meets the corresponding one of the one or more best practices attainment goals for each one of one or more customers of a business entity, and maintaining corresponding best practices resource allocations; and
determining, by the processor, that each one of the actual best practices attainment values does not at least meet the corresponding one of the one or more best practices attainment goals for each one of one or more customers of a business entity, and reallocating corresponding best practices resources.

2. The computer-implemented method of claim 1 wherein setting, by a processor, one or more best practices attainment goals for each one of one or more customers of a business entity comprises prioritizing, by the processor, one or more best practices attainment goals for each one of one or more customers of a business entity.

3. The computer-implemented method of claim 1 wherein collecting, by the processor, actual best practices attainment values achieved by each one of the one or more customers of a business entity comprises:
performing, by the processor, an accounting of metrics relating to best practices implementation categories;
determining, by the processor, one or more formulas that assign a score to each of the metrics relating to best practices implementation categories;
acquiring, by the processor, relative customer best practices data;
determining, by the processor, a score for each one of the best practices implementation categories; and
determining, by the processor, a ranking for each one of the best practices implementation categories in relation to the acquired relative customer best practices data.

4. The computer-implemented method of claim 3 wherein the best practices implementation categories comprise operational, environmental, workload, application and functional areas, and wherein the best practices implementation categories are grouped by geography, country, continent and industry.

5. The computer-implemented method of claim 3 wherein acquiring, by the processor, relative customer best practices data comprises customer profiling and analytics discipline techniques for data collection and curation.

6. The computer-implemented method of claim 3 wherein the best practices implementation categories comprise operational, environmental, workload, application and functional areas, and wherein determining, by the processor, a score for each one of the best practices implementation categories comprises determining, by the processor, a score for each of the operational, environmental, workload, application and functional areas.

7. The computer-implemented method of claim 1 wherein determining, by the processor, that each one of the actual best practices attainment values at least meets the corresponding one of the one or more best practices attainment goals for each one of one or more customers of a business entity, and maintaining corresponding best practices resource allocations comprises inputting, by the processor, each one of the actual best practices attainment values and one or more enterprise best practices attainment goals and priorities into an enterprise resource planning system.

8. A system comprising:
a processor in communication with one or more types of memory, the processor configured to:
set one or more best practices attainment goals for each one of one or more customers of a business entity;
collect actual best practices attainment values achieved by each one of the one or more customers of a business entity;
compare each one of the actual best practices attainment values to the corresponding one of the one or more best practices attainment goals for each one of one or more customers of a business entity;
determine that each one of the actual best practices attainment values at least meets the corresponding one of the one or more best practices attainment goals for each one of one or more customers of a business entity, and maintain corresponding best practices resource allocations; and
determine that each one of the actual best practices attainment values does not at least meet the corresponding one of the one or more best practices attainment goals for each one of one or more customers of a business entity, and to reallocate corresponding best practices resources.

9. The system of claim 8 wherein the processor configured to set one or more best practices attainment goals for each one of one or more customers of a business entity comprises the processor configured to prioritize one or more best practices attainment goals for each one of one or more customers of a business entity.

10. The system of claim 8 wherein the processor configured to collect actual best practices attainment values achieved by each one of the one or more customers of a business entity comprises the processor configured to:
perform an accounting of metrics relating to best practices implementation categories;
determine one or more formulas that assign a score to each of the metrics relating to best practices implementation categories;
acquire relative customer best practices data;
determine a score for each one of the best practices implementation categories; and
determine a ranking for each one of the best practices implementation categories in relation to the acquired relative customer best practices data.

11. The system of claim 10 wherein the best practices implementation categories comprise operational, environmental, workload, application and functional areas, and wherein the best practices implementation categories are grouped by geography, country, continent and industry.

12. The system of claim 10 wherein the processor configured to acquire relative customer best practices data comprises the processor configured to utilize customer profiling and analytics discipline techniques for data collection and curation.

13. The system of claim 10 wherein the best practices implementation categories comprise operational, environmental, workload, application and functional areas, and wherein the processor configured to determine a score for each one of the best practices implementation categories comprises the processor configured to determine a score for each of the operational, environmental, workload, application and functional areas.

14. The system of claim 8 wherein the processor configured to determine that each one of the actual best practices attainment values at least meets the corresponding one of the one or more best practices attainment goals for each one of one or more customers of a business entity, and maintain corresponding best practices resource allocations comprises the processor configured to input each one of the actual best practices attainment values and one or more enterprise best practices attainment goals and priorities into an enterprise resource planning system.

15. A computer program product comprising:
a non-transitory storage medium readable by a processing circuit and storing instructions for execution by the processing circuit for performing a method comprising:
setting, by a processor, one or more best practices attainment goals for each one of one or more customers of a business entity;
collecting, by the processor, actual best practices attainment values achieved by each one of the one or more customers of a business entity;
comparing, by the processor, each one of the actual best practices attainment values to the corresponding one of the one or more best practices attainment goals for each one of one or more customers of a business entity;
determining, by the processor, that each one of the actual best practices attainment values at least meets the corresponding one of the one or more best practices attainment goals for each one of one or more customers of a business entity, and maintaining, by the processor, corresponding best practices resource allocations; and
determining, by the processor, that each one of the actual best practices attainment values does not at least meet the corresponding one of the one or more best practices attainment goals for each one of one or more customers of a business entity, and reallocating, by the processor, corresponding best practices resources.

16. The computer program product of claim 15 wherein setting, by a processor, one or more best practices attainment goals for each one of one or more customers of a business entity comprises prioritizing, by the processor, one or more best practices attainment goals for each one of one or more customers of a business entity.

17. The computer program product of claim 15 wherein collecting, by the processor, actual best practices attainment values achieved by each one of the one or more customers of a business entity comprises:
performing, by the processor, an accounting of metrics relating to best practices implementation categories;
determining, by the processor, one or more formulas that assign a score to each of the metrics relating to best practices implementation categories;
acquiring, by the processor, relative customer best practices data;
determining, by the processor, a score for each one of the best practices implementation categories; and
determining, by the processor, a ranking for each one of the best practices implementation categories in relation to the acquired relative customer best practices data.

18. The computer program product of claim 17 wherein the best practices implementation categories comprise operational, environmental, workload, application and functional areas, and wherein the best practices implementation categories are grouped by geography, country, continent and industry.

19. The computer program product of claim 17 wherein acquiring, by the processor, relative customer best practices data comprises customer profiling and analytics discipline techniques for data collection and curation.

20. The computer program product of claim 17 wherein the best practices implementation categories comprise operational, environmental, workload, application and functional areas, and wherein determining, by the processor, a score for each one of the best practices implementation categories comprises determining, by the processor, a score for each of the operational, environmental, workload, application and functional areas.
